(19) United States
(12) Patent Application Publication
(10) Pub. No.: US 2007/0002410 A1
(43) Pub. Date: Jan. 4, 2007

(54) Hybrid halftoning

(76) Inventor: Peter I. Majewicz, Emmett, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/173,296

(22) Filed: Jun. 30, 2005

(51) Int. Cl. H04N 1/46; G06K 15/00

(52) U.S. Cl. 358/534; 358/3.06

(57) ABSTRACT

Systems, methods and devices, including program instructions, are provided for improving halftoning techniques. One method includes receiving continuous tone (contone) image pixel data and assigning a color within the contone image pixel data to a color channel associated with a hybrid halftoner.

### INTRODUCTION

Digital printers render continuous tone (contone) images by an approximating process termed halftoning. Halftoning is used because a printer is a binary device recreating a multi-level image. Halftoning results in output that attempts to replicate contone image input that has naturally contiguous image pixels. Halftoning is used in an effort to produce smooth transitions in intensity and color from discontinuous toner or pigment placement that is either present or absent. That is, a printer can either place or not place a discrete color pigment at a given location on a print medium. A contone image pixel may have 256 levels or more. The printer pixel has only 2—on or off. The printer therefore approximates the source image by varying the placement density of its pixels. A darker region of the image has a higher placement density.

Halftoning introduces defects into the recreated image. For example, the resolution is reduced and random noise, grain, and fixed pattern noise (FPN) are produced. Moiré is one example of FPN. Moiré is an interference pattern produced when print patterns are overlaid. For example, in color printing, the FPNs associated with each color can interact. The FPN can also interact with special frequencies inherent to the printer equipment, e.g., gear train impulses. These interactions are undesirable when they create frequencies detectable to the human visual system.

### BRIEF DESCRIPTION OF THE DRAWINGS

FIG. 1 is an example system for processing image data.

FIG. 2A illustrates an embodiment of a halftoning process applying a non-periodic halftoning technique to one color channel and a jointly-designed periodic and nonperiodic halftoning technique (e.g., “hybrid”) to another color channel of image data.

FIG. 2B illustrates another level of detail according to an embodiment of hybrid halftoning a color channel.

FIG. 2C illustrates another embodiment of a halftoning process applying a non-periodic halftoning technique to one color channel and a hybrid halftoning technique to another color channel of image data.

FIG. 3 illustrates three print samples illustrating a grayscale printed according to a periodic and stochastic halftoning technique in comparison to a grayscale printed according to a hybrid halftoning technique according to embodiments described herein.

FIG. 4A is a block diagram representing a halftoning method embodiment.

FIG. 4B is a block diagram representing another halftoning method embodiment.

FIG. 5 illustrates an example printing device suitable to implement embodiments described herein.

FIG. 6 illustrates an example network suitable to implement embodiments described herein.

### DETAILED DESCRIPTION

Systems, methods and devices, including program instructions, are provided for improving halftoning techniques. Embodiments include program instructions that execute to receive contone image input from a source. The program instructions execute to assign various colors to various color channels. According to embodiments, the program instructions execute to assign a particular color to a first channel. In the first channel, program instructions execute to operate on the first color using a jointly-designed periodic and nonperiodic halftoning technique (i.e., “hybrid” technique). The hybrid halftoning technique combines nonperiodic, e.g., stochastic, halftoning with periodic halftoning for use in processing pixel data for the first channel. According to various embodiments, the program instructions execute to assign another color to a second channel. In the second channel, program instructions execute to operate on the second color using a nonperiodic halftoning technique.

Halftone images are binary coded images that can be made from as few as two colors (e.g., black pigment on white print media) or from a multicolor palette forming patterns whose detailed structures are nearly invisible to the human visual system. For example, a color image printed with inks can be broken down into the colors cyan, magenta, yellow, and black. Each color can be “halftoned” into a binary image, having either a placement of color or nothing in a given printed area. These images thus convey an approximation of contone images.

Various types of scanning devices and displays, such as monitors, use the base colors red, green, and blue and, therefore, the monochrome colors of those devices include red, green, and blue, along with the shades of those colors. Various devices also use black as a base color and, therefore, black can also be a monochrome color with respect to these devices. However, the invention is not limited to the described colors or devices.

A processing unit handling input color channels through use of processing modules, e.g., halftoning modules, can be configured to receive and process pixel data in various ways. The processing unit can be preset to accept and assign various base colors to various color channels. A processing unit can be set when connected to a data source such that it is configured to receive the type(s) of data output from the data source, or it can be set when the type of data is identified by the controlling software or circuitry. The processing modules perform the processing and, depending upon how they are configured or programmed, affect how the image appears to the human visual system.

Periodic halftoning techniques vary toner or pigment placement density by tightly constrained patterning. Density increases follow a predetermined sequence of patterns. One pattern sequence is known as the Bayer Dither, as the same will be recognized by one of ordinary skill in the art. Other periodic techniques include screening and tiling. Periodic techniques are tuned to a particular printing application and can be designed to be robust against exhibiting print defects. A shortcoming, however, is the susceptibility to moiré, which is the interference pattern that occurs when print patterns are overlaid. In periodic halftoning techniques, moiré can be reduced by an arrangement of the print patterns for each color plane (or color channel) that involves rotating various print patterns to create angles between fundamental frequencies. For example, in an image processing configuration involving two color channels the print patterns are rotated 90 degrees between the two color channels to reduce interaction between fundamental frequencies. In a processing configuration involving three color channels the print patterns are rotated 30 degrees. This is done so that moiré is moved into portions of the available color palette having a lower visual impact. Rotations in a four or more color channel configuration are more difficult so compromises are made in the design of systems with four or more color channels.

Stochastic halftoning is an example of nonperiodic halftoning techniques. Stochastic halftoning techniques vary toner or pigment placement density through controlled randomization or pseudo-randomization of toner or pigment placement. Error diffusion and blue noise masks are examples of such techniques. The randomization precludes moiré and maintains good resolution, but it is susceptible to streaking, banding, and grain. The stochastic halftoning technique is difficult to tune for nonlinear processes, such as electrophotography (EP), because the randomization depends upon the linear assumptions of stable toner or pigment size and negligible toner or pigment crosstalk, characteristics that EP lacks.

The present application utilizes a combined or jointly-designed halftoning technique performed by computer executable program instructions to integrate periodic and nonperiodic (e.g., stochastic) halftoning techniques to process image data within the same color channel. The applicant's use of the term hybrid herein is intended to refer to both periodic and nonperiodic treatment within the same color channel. Embodiments described herein provide more degrees of freedom for tuning image processing to a particular application.

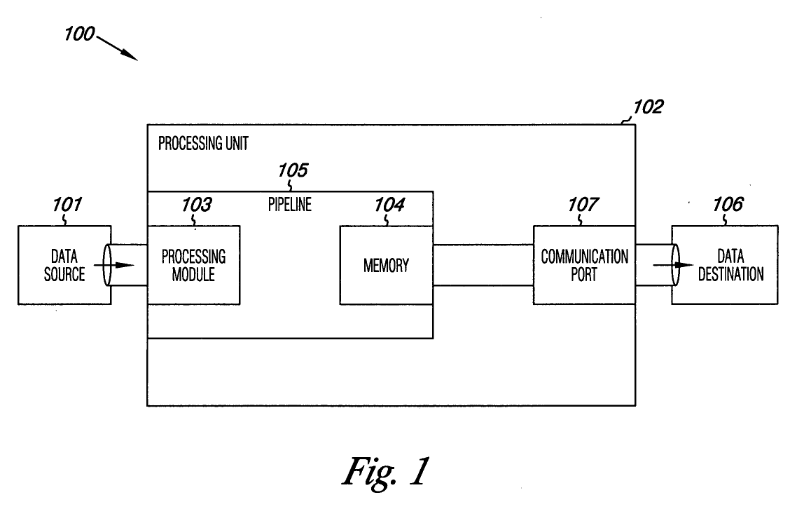

FIG. 1 illustrates an embodiment of a system 100 for processing data. FIG. 1 includes a data source 101 that provides pixel image data to be processed, a processing unit 102, and a data destination 106 for receiving the processed pixel image data. The processing unit 102 provides a processing pipeline 105 that can be used to process various color channels associated with various colors of pixel image data.

The data source 101 can include various data source types capable of outputting monochrome and/or color pixel data. For example, the data source 101 can be a device or component of a device that outputs color pixel image data such as a scanning device or computer display. The processing pipeline 105 can connect to a number of processing modules 103, memory 104, and communication port(s) 107. Examples of the functions that processing modules can provide include color space conversion and image enhancement, among others. Memory 104 can be resident on or connected to the processing unit 102. Memory 104 can be used to store program embodiments and processed data. Processed data can be routed from memory to various data destinations 106, e.g., an ink jet printing mechanism, laser printing mechanism, etc. The data destination 106 can receive the data via a communication port 107, e.g., via a peripheral component interconnect (PCI) bridge, and can print the transmitted color pixel image data on print media or display it in the form of an image.

A color can be represented by a single available base color and the various shades of that base color. For example, black is often available as a base color in printing devices and therefore is a monochrome color on those devices and a grayscale represents the shades of the color black. Printing devices also can include base colors such as cyan, magenta, yellow, light cyan, and light magenta, among others.

Color type pixel data can be represented according to various color space conventions. For example, various color space conventions include RGB (Red, Green, and Blue), CIE (Commission International de l'Eclairage tristimulus specification), LAB (Luminosity, A-chromaticity layer (red-green balance), and B-chromaticity layer (blue-yellow balance)), LCH (Luminance, Chroma, and Hue), and CMYK (Cyan, Magenta, Yellow, and Black), among others.

The pixel data types output from the data source 101 can be formatted in various bit lengths. For example, monochrome type pixel data can contain 1 bit of data where the one bit represents the presence or absence of a monochrome color. In another example, 8 bits of monochrome and/or color pixel data can represent 256 levels or values of that color. The 8 bits can be used to provide up to 256 different colors or 256 shades of a monochrome color. Data can be provided such that each pixel uses the same number of bits, e.g., 8 bits, or such that the pixels have different bit lengths, e.g., 2, 4, 6, or 8 bits. A number of bits can be grouped together to represent a number of colors in a pixel. For example, color type pixel data can use 32 bits to represent four different base colors in a pixel with each of the four different base color values represented by 8 bits of data.

The processing modules 103 within the processing unit 102 can include one or more integrated circuits or other structures that operate on program instructions, i.e., software and/or firmware, to perform pixel processing operations described herein. The embodiments of the invention, however, are not limited to any particular operating environment or to instructions written in a particular programming language. Software, firmware, and/or processing modules, suitable for carrying out embodiments of the present invention, can be resident in one or more devices or locations. Processing modules can include separate modules connected together or include several modules on an application specific integrated circuit (ASIC).

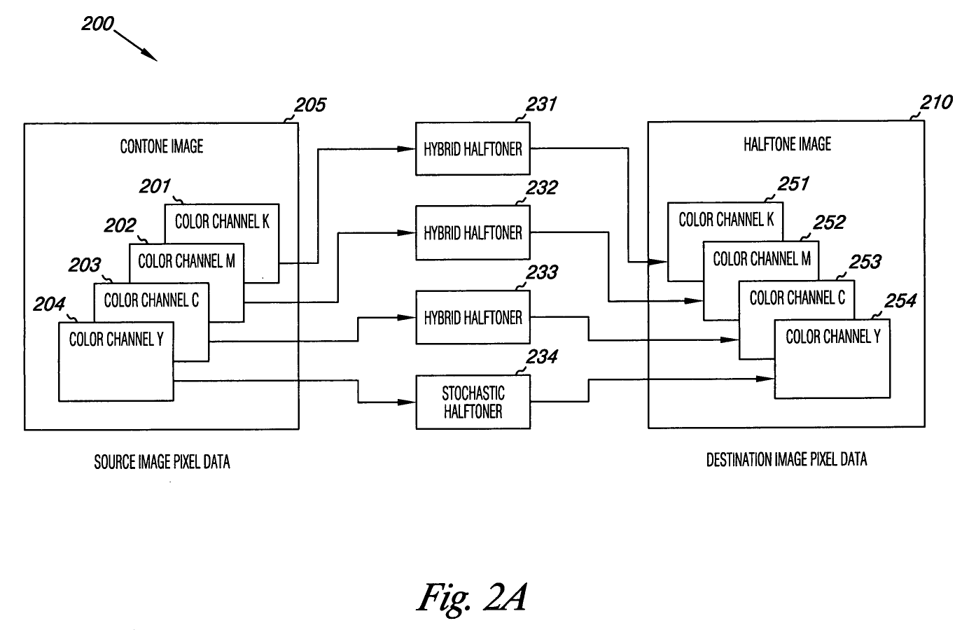

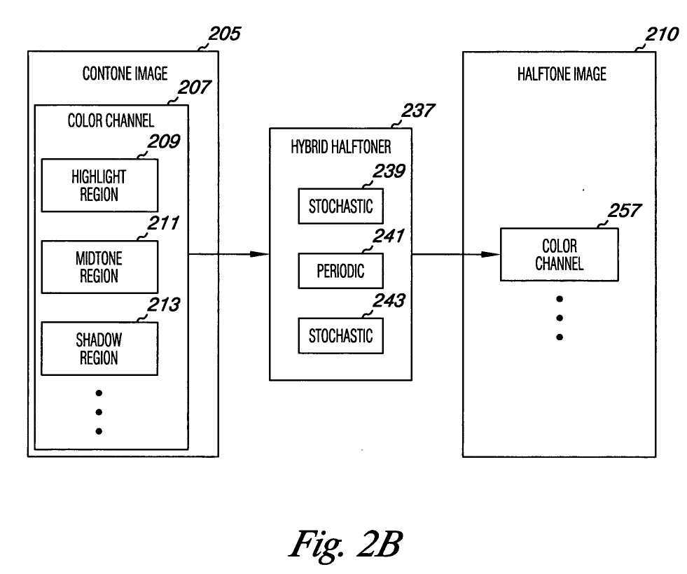

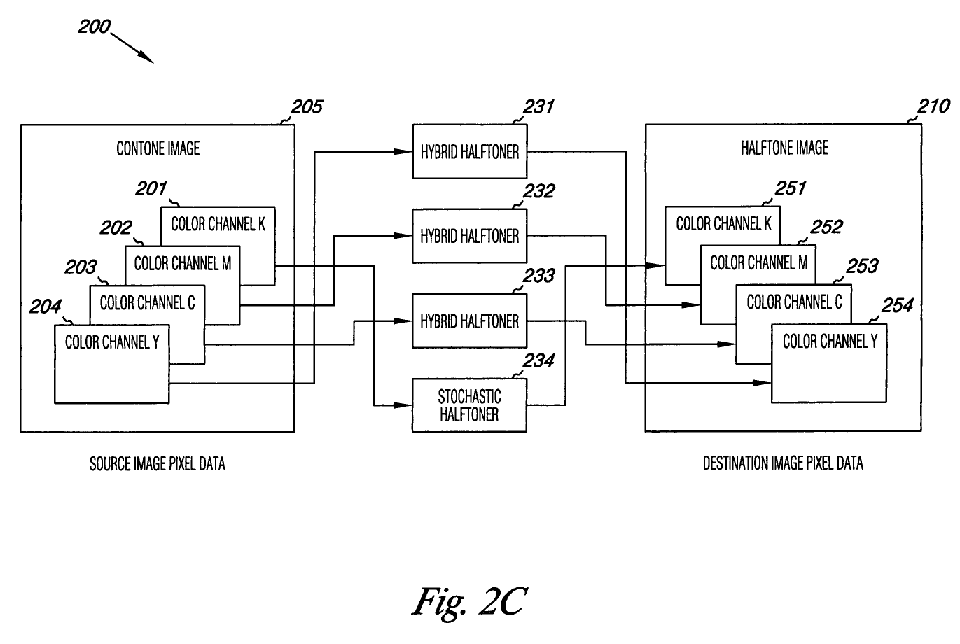

The pipeline 105 can be organized into a number of channels. For example, a 32 bit color data stream provided as color source image data input can represent four different colors and can be split into four different channels (e.g., cyan, magenta, yellow, and black) with each channel receiving 8 bits of data associated with a particular color. Embodiments, however, are not limited to this example. According to embodiments and as discussed in more detail in connection with FIGS. 2A-2C, various processing modules 103 are used to apply different halftoning techniques to various color channels within the pipeline 105.

FIGS. 2A-2C illustrate embodiments of a system 200 applying a non-periodic halftoning technique to one color channel and a hybrid halftoning technique to another color channel of image data. The system 200 of FIGS. 2A-2C can processes contone source image pixel data 205 received from a data source, e.g., 101 in FIG. 1, into halftone image pixel data 210 for output to a data destination, e.g., 106 in FIG. 1. The system 200 of FIGS. 2A-2C illustrates contone image data 205 which are stored digitally in “N” channels. The embodiments shown in FIGS. 2A and 2B, for example, illustrate four channels, 201 for black (K), 202 for magenta (M), 203 for cyan (C), and 204 for yellow (Y). Embodiments, however, are not limited to the number or type of color channels shown in the example embodiments of FIGS. 2A-2C. The system shown in FIGS. 2A-2C can be part of a processing unit having a number of processing modules as the same has been described in connection with FIG. 1. Each of the N channels, e.g., 201, 202, 203, 204, etc., feeds a halftoner module, e.g., shown as 231, 232, 233, and 234, respectively. These halftoner modules can include logic and/or executable instructions to perform the techniques described in the various embodiments herein.

According to various embodiments, of the N halftoners, 231, 232, 233, 234, etc., a number “P” of the halftoners employ a hybrid halftoning technique that implements both a periodic and nonperiodic halftoning operation on the image pixel data in their particular channel(s). Additionally, a number “Q” of the halftoners employ a nonperiodic halftoning operation on the image pixel data in their particular channel(s). The designators P and Q are nonzero and can represent an equal or different number of channels. As will be explained in more detail below, the system 200 described can improve the halftoning process for recreating contone image by having some of the channels be operated on by the hybrid technique with the remainder utilizing a nonperiodic, e.g., stochastic, technique.

The reader will appreciate the manner in which a given contone image 205 can be digitally encoded by assigning each pixel a number of image pixel values according to the number of colors channels in the image processing system. For example, in the embodiments of FIGS. 2A and 2C, a pixel value is assigned for the four colors K, M, C, and Y, respectively. Each of the four pixel values is further assigned to a channel, 201, 202, 203, 204, etc. The encoded values travel to the associated halftoners, 231, 232, 233, and 234, which operate on the four pixel values to produce halftoned pixel value outputs, shown at 251, 252, 253, and 254 respectively.

In the embodiment of FIG. 2A the P halftoners are associated with the K, M, and C color channels, 201, 202, and 203 respectively. That is, program instructions and/or logic for halftoners 231, 232, and 232, operate on the image pixel data received in these channels to combine a periodic halftoning technique, e.g., screening, tiling, etc., with a nonperiodic, e.g., stochastic, halftoning technique. Error diffusion and blue noise masks are examples of stochastic techniques. The combined periodic and nonperiodic halftoning techniques produce halftoned image pixel data output, shown as 251, 252, and 253, for color channels K, M, and C respectively.

In the embodiment of FIG. 2A the Q halftoner is associated with the Y color channel 204. According to this embodiment, program instructions and/or logic for halftoner 234 operates on the source image pixel data received in the Y channel to perform a nonperiodic halftoning technique thereto. In this example, halftoner 234 is a stochastic halftoner 234 and applies a halftoning technique such as error diffusion, blue noise mask, etc., to the image pixel data to produce halftoned image pixel data 254 as output for color channel Y.

The embodiment of FIG. 2A thus provides a useful assignment mixture for a four ink printer having CMYK color channels. In this example embodiment yellow is assigned to a stochastic halftoner, with the other three colors assigned to halftoners utilizing the hybrid technique. Although the randomness of the stochastic technique makes it more susceptible to streaking, grain, and banding, yellow (Y) has the lowest visual impact of the four colors, which makes the streaking, grain, and banding issues less perceptible to the human visual system. In FIG. 2A the CMK channels, 201, 202, and 203, are connected to the hybrid halftoning modules, 231, 232, and 233, because the hybrid halftoning technique can be more robust against nonlinearities, e.g., non-stable toner or pigment size, appreciable toner or pigment crosstalk, engine defects, etc., in a given printing device and the CMK channels have a perceptible impact on the human visual system. For example, changes in tone, e.g., resulting from nonlinearities in a system, result in changes in lightness which the human visual system is sensitive to. By contrast, Y channel changes, e.g., due to nonlinearities, cause chroma changes. The human visual system is relatively insensitive to chroma changes. Thus, by way of example and not by way of limitation, the embodiment illustrated in FIG. 2A works well for general purpose printing and in printing images with natural scenes and large area fills.

FIG. 2B illustrates another level of detail according to an embodiment of hybrid halftoning a color channel. As shown in the embodiment of FIG. 2B, contone image pixel data 205 can be broken down into values assigned to various color channels, e.g., 207 (also referred to as different color planes). As described in connection with FIG. 2A, each color plane or color channel can be treated differently with one or more color channels being operated on by a hybrid halftoning module, e.g., 237 in FIG. 2B. Various color channels 207 will include tone scale regions within the channel. In the embodiment of FIG. 2B, color channel 207 is represented with three tone scale regions illustrated as highlight region 209, midtone region 211, and shadow region 213. One of skill in the art will appreciate that faces, clouds, pastel colors, etc. in a contone image can be located in the highlight region 209. Bright graphics such as pie charts can be located in the midtone region 211. And, earth tones, navy, etc., can be located in the shadow region 213. Embodiments are not limited to this example of tone scale regions for color channels.

FIG. 2B illustrates the color channel 207 connected to a hybrid halftoning module 237. According to the embodiment of FIG. 2B, program instructions and/or logic in hybrid halftoning module 237 operates on the image pixel data of channel 207 to perform a nonperiodic halftoning technique, e.g., stochastic halftoning technique, on a highlight region 209 of the image pixel data. In this example embodiment, the program instructions and/or logic in hybrid halftoning module 237 operates to perform a periodic halftoning technique on a midtone region 211 of the image pixel data. And, according this embodiment, the program instructions and/or logic in the hybrid halftoning module 237 operate to perform a nonperiodic halftoning technique on a shadow region 213 of the image pixel data. Operating on the various tone scale regions of color channel 207 in this manner produce halftoned image pixel data output shown at color channel 257.

One example implementation of the above described embodiment is with dry electrophotographic (EP) print engines. It is desirable for dry EP engines to render midtones with periodic halftoning. The periodic nature produces pleasing uniform fills that are robust against engine defects such as streaks, bands, and mottle. It is similarly desirable to render highlights and shadows with stochastic halftoning. The stochastic nature reduces the visual impact of isolated toner placement and holes used to produce these tones. The above described embodiment for differentiating the treatment of the tone scale regions within a given color channels affords such a capability and more finely divides the image space.

FIG. 2C is another example embodiment dividing the treatment of various color channels between P hybrid halftoning modules and Q nonperiodic halftoning modules. In the embodiment of FIG. 2C the P halftoners are associated with the Y, M, and C color channels, 204, 202, and 203 respectively. The program instructions and/or logic for halftoners 231, 232, and 232, operate on the source image pixel data received in these channels to combine a periodic halftoning technique with a nonperiodic halftoning technique, as described above. The combined periodic and nonperiodic halftoning techniques produce halftoned image pixel data output, shown as 254, 252, and 253, for color channels Y, M, and C respectively.

In the embodiment of FIG. 2C the Q halftoner is associated with the K color channel 201. According to this embodiment, program instructions and/or logic for halftoner 234 operates on the source image pixel data received in the K channel to perform a nonperiodic halftoning technique thereto. In this example, halftoner 234 applies a stochastic halftoning technique such as error diffusion to the image pixel data to produce halftoned image pixel data 251 as output for color channel K. Error diffusion has the sometimes desirable characteristic of following and sharpening edges. Thus, one example implementation of this embodiment includes use in printing a document that has a high amount of gray content and/or for a scanned document where the text comes through the imaging pipeline as less than 100% black. Gray text that is periodically halftoned is susceptible to jagged edges, but not if error diffused, i.e., stochastically treated.

Thus, the embodiment of FIG. 2C illustrates a useful mixture of hybrid halftoners assigned to various colors channels with the color black being assigned to a stochastic halftoner. Colored images have minimal black content or are printed with a CMY blend substituting for black. In these images, the problems associated with the stochastic technique are either absent because black is not present or their presence is limited to the shadow regions where black is used. The above described printing concerns are not particularly noticeable in shadow regions. Moreover, documents containing both images and black text preferably display text with sharp margins. The higher resolution of halftoners using the stochastic technique aids in sharp reproduction of black text content while affording the hybrid treatment advantages to other color channels.

The reader will appreciate that the embodiments described in connection with FIGS. 2A-2C can be performed within various processing modules with an image processing pipeline of a processing unit as the same was illustrated in FIG. 1. According to various embodiments, the number of processing modules includes at least one hybrid halftoning module. In various embodiments a user can set a bit to select which color channels are to be treated with which sort of halftoning module. A user thus is afforded a means for adjusting the processing of pixel data according to various printing scenarios. That is, a user can determine which channels are assigned to the nonperiodic technique and which are assigned to the hybrid technique. Additionally, as described in more detail below, the hybrid halftoning module can be configured to adjust a balance between periodic and nonperiodic techniques in order to achieve a desired visual effect.

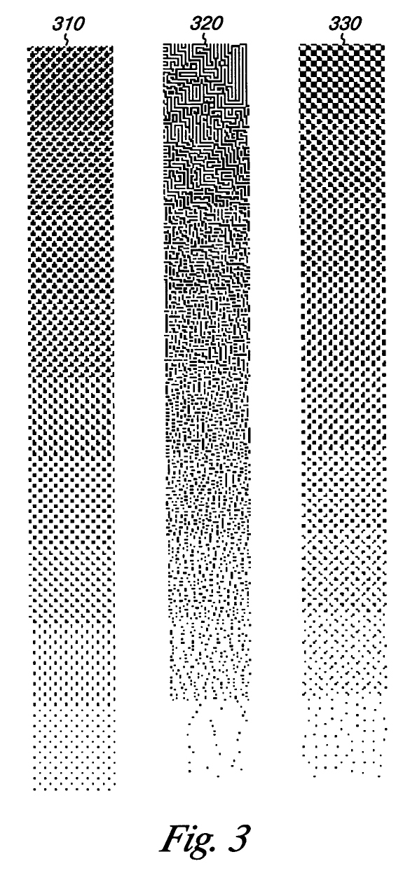

FIG. 3 illustrates three print samples illustrating a grayscale printed according to a periodic 310 and stochastic 320 halftoning technique in comparison to a grayscale printed according to a hybrid halftoning technique 330 according to embodiments described herein. Although it is possible to splice together different methods within the hybrid halftoning described above, the transitions in the grayscale may be quite noticeable. Thus, according to various embodiments, the program instructions and/or logic of the hybrid halftoning module grow the periodic patterns in a piecewise stochastic manner. That is, in various embodiments the halftoning pattern is periodically structured but each tone level increment is partly randomly different than the other parts. As such, transitions between strongly periodic and strongly stochastic are smooth as illustrated by print sample 330. The mixtures described herein can be controlled in a number of manners to achieve a desired balance.

The halftone system disclosed herein provides additional degrees of freedom that can be used to tune an image processing system for a given printing application more effectively than when using a system that uses one technique for all channels and even systems that use certain channels dedicated to periodic techniques and other channels dedicated to nonperiodic techniques. The systems described herein allow hybrid halftoners embodiments to be assigned color channels that are more susceptible to nonlinearities. Stochastic halftoners can be assigned to less problematic channels and/or channels with less inherent visual impact. The presence of even one stochastically halftoned channel notably minimizes moiré in systems using three or four colors and the effect becomes even more evident when a greater number of colors are added to the palette. While the above example embodiments have been discussed in connection with four color channels the embodiments are not limited to four color channel examples. A larger and/or smaller number of color channels can benefit from the embodiments described herein.

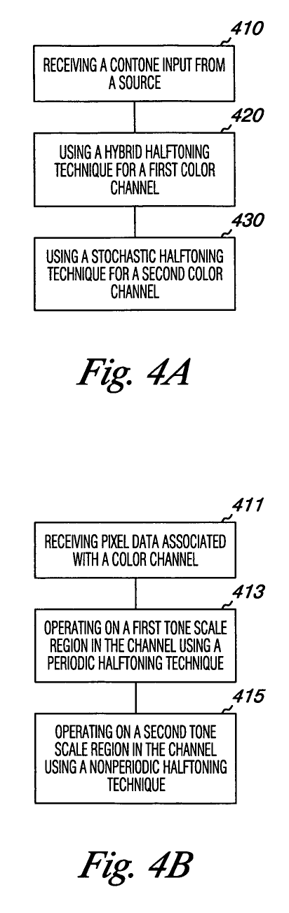

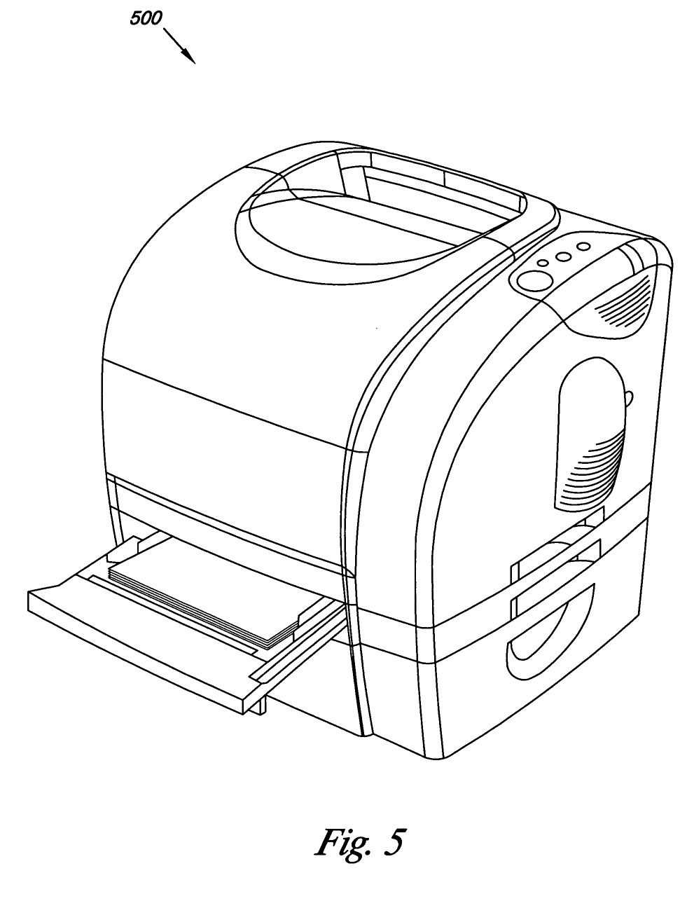

FIGS. 4A and 4B illustrate various method embodiments according to the present invention. Unless explicitly stated, the method embodiments described herein are not constrained to a particular order or sequence. Additionally, some of the described method embodiments or elements thereof can occur or be performed at the same point in time. The embodiments can be performed by software and/or firmware (i.e., computer executable instructions), hardware, application modules, and the like, executable and/or resident on the systems and devices shown herein or otherwise.

FIG. 4A is a block diagram representing a halftoning method embodiment. In the embodiment of FIG. 4A, a method for processing pixel data is illustrated. In block 410, the method includes receiving contone image data from a source. A number and type of base color channels can be preset within the processing unit, elsewhere in an image processing pipeline, or can be determined based upon characteristics of the image data input. For example, the number of channels can be defined on an integrated circuit, such as an ASIC. Each channel can be designed to process a particular color element of a stream of color type pixel data.

The embodiments of the invention can handle the various types and numbers of contone input channels. For example, a color pixel can be formed by elements of a number of base colors available from a source, such as red, green, and blue, for an image in an RGB color space of a monitor and/or a color space of a scanning device. In the embodiments described herein, the source image data, e.g., the RGB pixels values of a monitor, can be converted to a color space used by a printing device, e.g., CMYK. Each color plane, e.g., color channel, of the printing device's color space will be assigned a particular source image pixel value and assigned to a particular color channel for the particular image processing system. These pixel values can be received in source image pixel data as described in FIGS. 1 and 2A-2C. The pixel values can be further processed in an image processing pipeline to deliver source image pixel data to a halftoning module as the same has been described herein.

As shown in the embodiment of FIG. 4A in block 420, the method includes using a hybrid halftoning technique, as the same has been described herein, for a first color channel. And, according to various embodiments, the method includes using a stochastic halftoning technique for a second color channel, e.g., as shown in block 430.

FIG. 4B is a block diagram representing another halftoning method embodiment. In the embodiment of FIG. 4B the method includes receiving pixel data associated with a color channel. According to various embodiments the particular color channel can be a user defined color channel. As shown in the embodiment of FIG. 4B the method includes operating on a first tone scale region in the channel using a periodic halftoning technique, as shown in block 413. An example of the same has been described in connection with FIG. 2B, e.g., midtone region of image pixel data. Embodiments, however, are not limited to the example embodiment of FIG. 2B. FIG. 4B further illustrates operating on a second tone scale region in the channel using a nonperiodic halftoning technique, as shown in block 415. An example of the same has been described in connection with FIG. 2B, e.g., highlight and shadow regions of image pixel data. Again, embodiments are not limited to the example embodiment of FIG. 2B.

FIG. 5 illustrates an example printing device 500 suitable to implement embodiments described herein. The printing device 500 can assign various color channels to a hybrid halftoner. The printing device can further assign various color channels to a dedicated nonperiodic halftoner which is not a hybrid halftoner. In various embodiments, the printing device 500 can be user configured to any number of color channels. The printing device 500 can represent an ink jet printer or a laser printer using dry or liquid EP. Embodiments are not so limited.

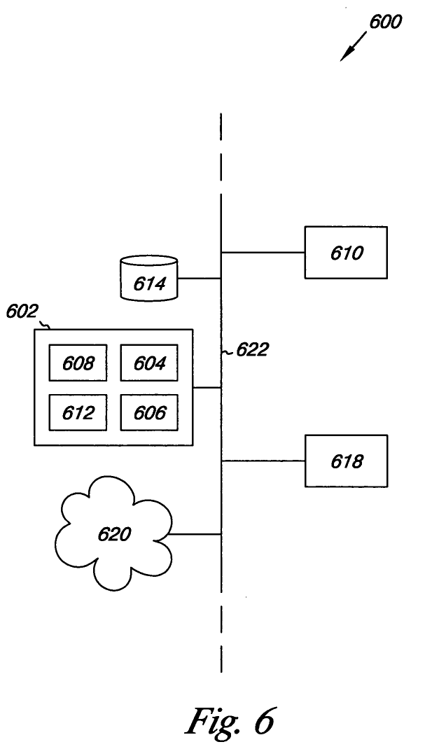

FIG. 6 illustrates an example network 600 suitable to implement the hybrid halftoning embodiments described herein. The network 600 of FIG. 6 includes a printing device 602 and includes an image source device such as a host computer display and/or a scanning device, e.g., 618. The printing device 602 is operable to print a sheet, e.g., print media, having one or more images, which may contain text, images and/or graphics, etc., that are applied to the print media using halftoning techniques described herein. That is, various processing modules can be included in the printing device 602, some which perform a nonperiodic, e.g., stochastic, halftoning technique and some which perform a hybrid halftoning technique on various color channels.

The printing device 602 can include one or more processors 604 and one or more memory devices 606. In one embodiment the processor 604 and memory 606 are operable to execute program instructions to implement the hybrid halftoning techniques described herein. In the embodiment of FIG. 6, the printing device 602 is illustrated including a printing device driver 608 and a print engine 612. In one embodiment, the print engine 612 includes the program instructions and/or logic to perform the hybrid halftoning techniques described herein. Various additional printing device drivers can be located off the printing device, for example, on the remote device 610. Such printing device drivers can be an alternative to the printing device driver 608 located on the printing device 602 or provided in addition to the printing device driver 608. A printing device driver 608 is operable to create a computer readable instruction set for a print job utilized for rendering an image by the print engine 612.

As shown in the embodiment of FIG. 6, printing device 602 can be networked to one or more remote devices 610 over a number of data links, shown as 622. The number of data links 622 can include one or more physical and one or more wireless connections, and any combination thereof, as part of a network. That is, the printing device 602 and the one or more remote devices 610 can be directly connected and can be connected as part of a wider network having a plurality of data links 622.

The remote device 610 can include a device having a display, or monitor, such as a desktop computer, laptop computer, a workstation, hand held device, etc. Likewise, the remote device 610 can include a scanner or other device as the same will be known and understood by one of ordinary skill in the art. The remote device 610 can also include one or more processing units and/or processing modules suitable for running software and can include one or more memory devices thereon according to embodiments described herein. FIG. 6 illustrates that one or more storage devices 614, e.g., remote storage database, etc., can be connected to the network 600. Likewise, the network 600 can include one or more peripheral devices 618, Internet connections 620, etc. The network 600 illustrated in FIG. 6 can include any number of network types including, but not limited to, a Local Area Network (LAN), a Wide Area Network (WAN), Personal Area Network (PAN), and/or a wireless LAN, WAN, and/or PAN. As stated above, data links 622 within such networks can include any combination of direct or indirect wired and/or wireless connections, including but not limited to electrical, optical, and RF connections.

Although specific embodiments have been illustrated and described herein, it is to be understood that the above descriptions have been made in an illustrative fashion and not a restrictive one. Those of ordinary skill in the art will appreciate that an arrangement calculated to achieve the same results with different permutations of the disclosed techniques can be substituted for the specific embodiments shown or described. This disclosure is intended to cover adaptations or variations of the described embodiments of the invention. Alternative combinations of the above embodiments, and other embodiments not specifically described herein, will be apparent to those of skill in the art upon reviewing the above description. The scope of the various embodiments of the invention includes other applications in which the software, firmware, hardware, devices, methods, and systems described herein are utilized. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter may lie in less than all features of a single disclosed embodiment. Thus, the following claims are hereby incorporated into the Detailed Disclosure by reference, with each claim standing on its own as a separate embodiment.

What is claimed:

1. A method for hybrid halftoning, comprising:
receiving continuous tone (contone) image pixel data from a source; and
assigning a first color within the contone image pixel data to a first color channel associated with a hybrid halftoner.

2. The method of claim 1, wherein the method includes using the hybrid halftoner to apply a jointly-designed periodic and a nonperiodic halftoning technique to the first color.

3. The method of claim 1, wherein the method includes receiving the contone image pixel data to an electrophotography image processing system and includes applying the periodic halftoning technique to a midtone region of the first color channel.

4. The method of claim 1, wherein the method includes assigning a second color within the contone image pixel data to a second color channel associated with a nonperiodic halftoner.

5. The method of claim 4, wherein the method includes associating a yellow color channel with the nonperiodic halftoner and assigning two or more other color channels to a hybrid halftoner.

6. The method of claim 4, wherein the method includes receiving the contone image pixel data to a four channel image processing system and includes associating a black color channel with a stochastic halftoner when the contone image pixel data include a representation of black text.

7. The method of claim 1, wherein the method includes variably assigning a second color channel to a nonperiodic halftoner.

8. A method for hybrid halftoning, comprising:
receiving continuous tone (contone) image pixel data from a source;
applying a periodic and a nonperiodic halftoning technique to a first color channel associated with the contone image pixel data; and
applying a nonperiodic halftoning technique to a second color channel associated with the contone image pixel data.

9. The method of claim 8, wherein the method includes applying the periodic halftoning technique to a midtone scale region of the first color channel and applying the nonperiodic halftoning technique to a highlight scale region and a shadow scale region of the first color channel.

10. The method of claim 8, wherein the method includes receiving contone image pixel data to a dry electrophotography image processing system including four color channels.

11. The method of claim 8, wherein the method includes applying a periodic and a stochastic halftoning technique to the first color channel and applying a stochastic halftoning technique to the second color channel.

12. The method of claim 8, wherein the method includes applying a stochastic halftoning technique to a yellow color channel.

13. A printing device, comprising:
a processor;
a memory coupled to the processor;
an input/output (I/O) channel coupled to the processor to receive continuous tone (contone) image pixel data; and
means for processing a color channel associated with the contone image pixel data according to both a periodic and a nonperiodic halftoning technique.

14. The device of claim 13, wherein the means includes program instructions executable to apply both the periodic and the nonperiodic halftoning technique to the color channel.

15. The device of claim 14, wherein the program instructions are executable to process the contone image pixel data in the color channel by applying a halftoning pattern that is periodically structured but in which each tone level increment is randomly different than others.

16. The device of claim 14, wherein the device includes program instructions to process a different color channel associated with the contone image pixel data according to a nonperiodic halftoning technique.

17. A printing device, comprising:
logic and memory associated with an image processing pipeline of the device; and
instructions storable in the memory and executable by the logic to:
apply a combined periodic and nonperiodic halftoning technique to a first color channel of the pipeline; and
apply a nonperiodic halftoning technique to a second color channel of the pipeline.

18. The device of claim 17, wherein the instructions are executable to variably assign a color to the second color channel based on a content of received image pixel data.

19. The device of claim 17, wherein, in the first color channel, the instructions are executable to apply a periodic halftoning technique to a first tone scale region and are executable to apply the nonperiodic halftoning technique to a second tone scale region.

20. The device of claim 17, wherein the device is a dry electrophotographic printer and the image processing pipeline includes four color channels, and wherein three of the color channels are treated by a jointly-designed periodic and nonperiodic halftoner and a fourth color channel is treated by a nonperiodic halftoner.

21. The device of claim 17, wherein the instructions include instructions executable to receive a continuous tone (contone) image data from a scanner connected via a network to the device and to input the contone image data to the pipeline.

22. A computer readable medium having executable instructions thereon for causing a device to perform a method, comprising:
receiving continuous tone (contone) image pixel data from a source; and
assigning a first color within the contone image pixel data to a first color channel associated with a hybrid halftoner.

23. The medium of claim 22, wherein the method includes using the hybrid halftoner to apply a jointly-designed periodic and a nonperiodic halftoning technique to the first color.

24. The medium of claim 22, wherein the method includes receiving the contone image pixel data to an electrophotography image processing system and includes applying the periodic halftoning technique to a midtone region of the first color channel.

25. The medium of claim 22, wherein the method includes assigning a second color within the contone image pixel data to a second color channel associated with a nonperiodic halftoner.

26. The medium of claim 25, wherein the method includes associating a yellow color channel with the nonperiodic halftoner and assigning two or more other color channels to a hybrid halftoner.

27. The medium of claim 25, wherein the method includes receiving the contone image pixel data to a four channel image processing system and includes associating a black color channel with a stochastic halftoner when the contone image pixel data include a representation of black text.

28. The medium of claim 22, wherein the method includes variably assigning a second color channel to a nonperiodic halftoner.

29. A computer readable medium having executable instructions thereon for causing a device to perform a method, comprising:
receiving continuous tone (contone) image pixel data from a source;
applying a periodic and a nonperiodic halftoning technique to a first color channel associated with the contone image pixel data; and
applying a nonperiodic halftoning technique to a second color channel associated with the contone image pixel data.

30. The medium of claim 29, wherein the method includes applying the periodic halftoning technique to a midtone scale region of the first color channel and applying the nonperiodic halftoning technique to a highlight scale region and a shadow scale region of the first color channel.

31. The medium of claim 29, wherein the method includes receiving contone image pixel data to a dry electrophotography image processing system including four color channels.

32. The medium of claim 29, wherein the method includes applying a periodic and a stochastic halftoning technique to the first color channel and applying a stochastic halftoning technique to the second color channel.

33. The medium of claim 29, wherein the method includes applying a stochastic halftoning technique to a yellow color channel.
